(19) United States
(12) Patent Application Publication
(10) Pub. No.: US 2012/0312175 A1
(43) Pub. Date: Dec. 13, 2012

(54) ALTERNATE GRILL

(75) Inventor: Jianli XU, Zhangzhou (CN)

(73) Assignee: TSANN KUEN (ZHANGZHOU) ENTERPRISE CO., LTD., Zhangzhou (CN)

(21) Appl. No.: 13/495,854

(22) Filed: Jun. 13, 2012

(30) Foreign Application Priority Data
Jun. 13, 2011 (CN) 201120197742.X

(51) Int. Cl. A47J 37/06

(52) U.S. Cl. 99/339

(57) ABSTRACT

An alternate grill has an upper pan and a lower pan, an upper heating member and a lower heating member for heating the two pans respectively. The lower heating member comprises at least a first heating unit and a second heating unit. In the position that the two pans are folded as a grill, the upper heating member and the first heating unit are electrified, while the second heating unit is power-off; in the position that the two pans are unfolded as two grilling pans, the second heating unit and the first heating unit are electrified, while the upper heating member is power-off. In unfolded status, the power in two heating surface can be switched to one heating surface, thus the heating time can be shorten, and the food can be cooked more delicious by high power. The alternation can be switched using a switch.

### FIELD OF THE INVENTION

The present invention relates to a grill, more particularly, to an alternate grill which can switch the heating zone of the grill according to different temperature requirements in cooking.

### BACKGROUND OF THE INVENTION

The grill in market usually comprises an upper pan and a lower pan, and the upper pan and lower pan are used as an upper heating body and a lower heating body. in cooking, the two pans can be folded as a grill for grilling food both from up and bottom, or be unfolded as two pans only heating food from bottom. in unfolded status, the two pans can be 105° or 180° to each other. In folded status, the food are heated both from up and bottom, and the food is in a closed room, so the grilling effect is well. While in unfolded status, because the heating energy are losing seriously, so the grilling effect is not well.

### SUMMARY OF THE INVENTION

The primary object of the present invention is to provide an alternate grill, to obviate the above problem in background.

The solution of the present invention is as follows:

an alternate grill, comprising an upper pan and a lower pan, and an upper heating member and a lower heating member for heating the two pans respectively, said lower heating member comprising at least a first heating unit and a second heating unit, in the position that the two pans are folded as a grill, said upper heating member and said first heating unit are electrified, while said second heating unit is power-off; in the position that the two pans are unfolded as two grilling pans, said second heating unit and said first heating unit are electrified, while said upper heating member is power-off.

In a preferred embodiment of the present invention, the present invention further comprising a switch for switching the power-on or power-off status for said upper heating member and said second heating unit alternately.

In a preferred embodiment of the present invention, said upper heating member and lower heating member are electrical heating tubes.

In a preferred embodiment of the present invention, said second heating unit is parallel to the first heating unit around the outer side by a certain distance.

In a preferred embodiment of the present invention, said upper pan and said lower pan has a folded position, a 105° position and a 180° position to each other.

By above description, the alternate grill of the present invention comprising an upper pan and a lower pan, and an upper heating member and a lower heating member for heating the two pans respectively, said lower heating member comprising at least a first heating unit and a second heating unit, in the position that the two pans are folded as a grill, said upper heating member and said first heating unit are electrified, while said second heating unit is power-off; in the position that the two pans are unfolded as two grilling pans, said second heating unit and said first heating unit are electrified, while said upper heating member is power-off. Because the second heating unit and the upper heating member are power-on or power-off alternately, compared to the grill in market, the present invention can switch the cooking effect of the heating surface, make the heating energy to be used more effectively. In unfolded status, the power in two heating surface can be switched to one heating surface, thus the heating time can be shorten, and the food can be cooked more delicious by high power. And the alternation can be switched only by a switch.

### BRIEF DESCRIPTION OF THE DRAWINGS

FIG 1 is an exploded view of the present invention;

FIG. 2 is a sectional view of the present invention in folded status;

FIG. 3 is a sectional view of the present invention in 105° position;

FIG. 4 is a perspective view of the present invention in 180° position;

FIG. 5 is a circuit diagram of the present invention.

### DETAILED DESCRIPTION OF PREFERRED EMBODIMENT

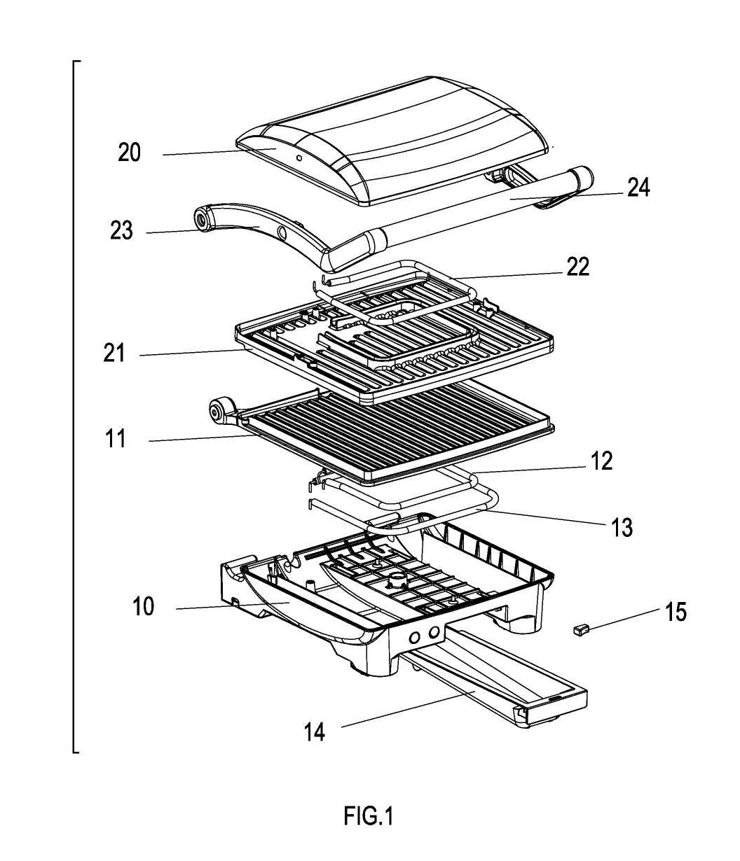

Referring to FIG. 1 to FIG. 4, the alternate grill of the present invention comprise a lower shell 10, an upper shell 20, a lower pan 11 disposed on the upper surface of the lower shell 10, and an upper pan 21 disposed on the bottom of the upper shell 20.

In the rear side of the lower pan 11 on the lower shell 10, there disposed two approximately rectangular tubes, the first electrical heating tube 12 and the second electrical heating tube 13, herein the rectangle of the second electrical heating tube 13 is bigger than the rectangle of the first electrical heating tube 12, and the second electrical heating tube 13 is parallel to the first electrical heating tube 12 on the outer side by a certain distance. An oil box 14 for collecting the oil in grilling is disposed in the bottom of the lower shell 10.

An approximately rectangular tube (the upper electrical heating tube 22) is disposed in the rear side of the upper pan 21 on the upper shell 20. Both sides of the upper shell 20 are disposed a lever 23, and a handle 24 is connected between the top ends of the two levers 23. In the 180° status, the two levers 23 and the handle 24 are used for supporting the upper shell 20 and the upper pan 21.

Herein, a switch 15 is disposed on the right side of the lower portion of the lower shell 10, which is used for switching the upper electrical heating tube 22 and the second electrical heating tube 13. I.e., turn the switch 15 in a direction, the upper electrical heating tube 22 is electrified, while the second electrical heating tube 13 is power-off; while turn the switch 15 in another direction, then the upper electrical heating tube 22 are power-off, while the second electrical heating tube 13 is electrified. Thus the upper electrical heating tube 22 and the second electrical heating tube 13 can be switched alternatively.

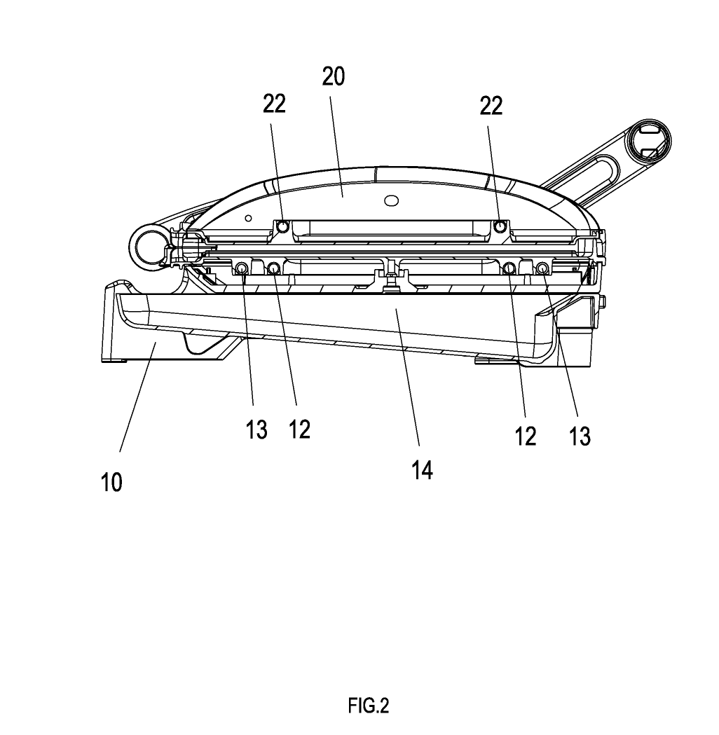

Referring to FIG. 2, when the upper pan and lower pan are folded, the first electrical heating tube 12 and the upper electrical heating tube 22 are electrified, while the second electrical heating tube 13 is power-off. In this status, the food are heated both by the upper pan and the lower pan.

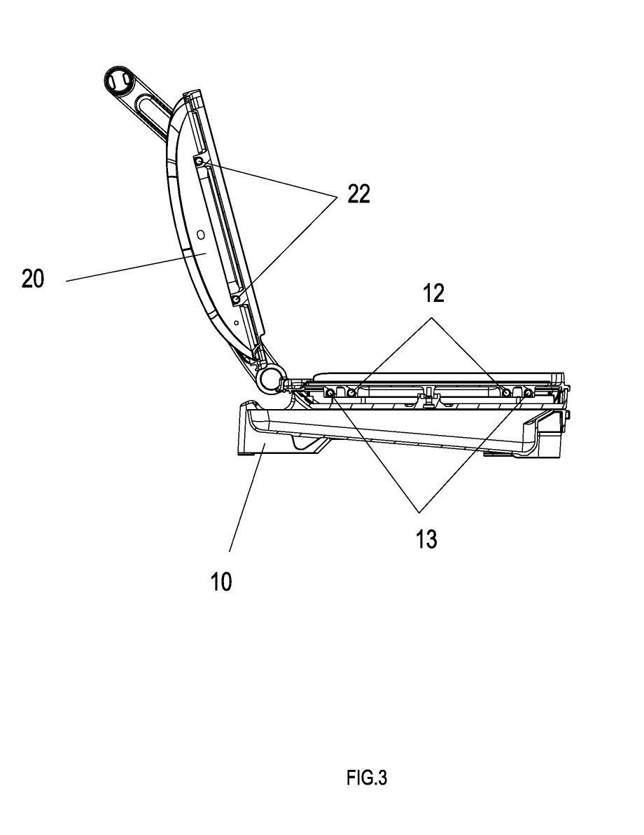

Referring to FIG. 3, when the upper pan and lower pan are unfolded in 105°, the first electrical heating tube 12 and the second electrical heating tube 13 are electrified, and the upper electrical heating tube 22 is power-off. In this status, the power of the lower pan is enhanced to obviate the problem that the power is not enough after opened.

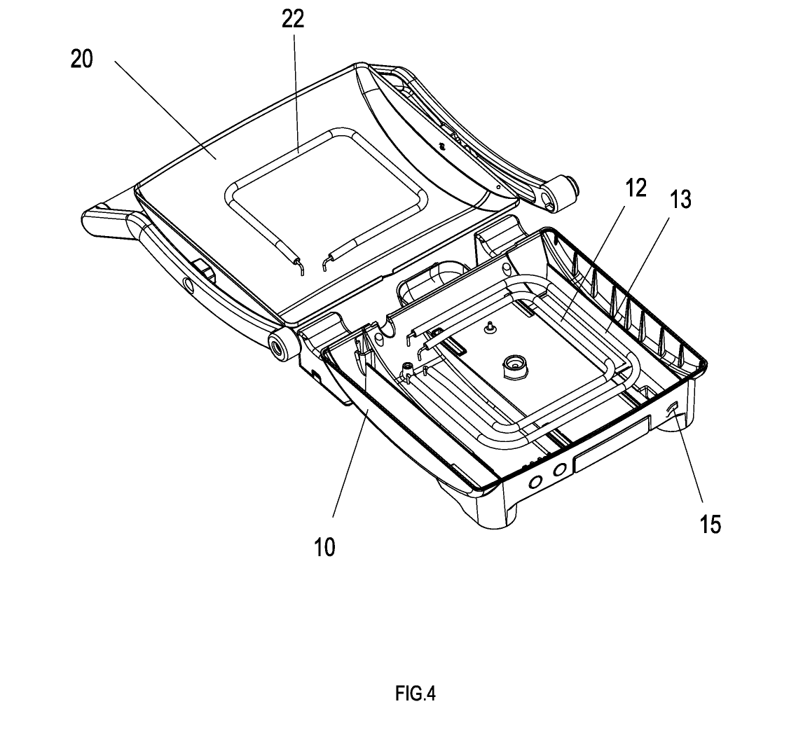

Referring to FIG. 4, when the upper pan and lower pan are unfolded in 180°, if this status is switched from 105°, the switch 15 is not necessary to be turned,; if it is switched from folded status, then turn the switch 15. Herein the first electrical heating tube 12 and the second electrical heating tube 13 are electrified, while the upper electrical heating tube 22 is power-off. In this status, power of the lower pan is enhanced to obviate the problem that the power is not enough after opened.

If the two pans are switched to folded status from 180° or 105°, it only needed to turn the switch 15 in a reverse direction, then the upper electrical heating tube 22 is electrified and the second electrical heating tube 13 is power-off.

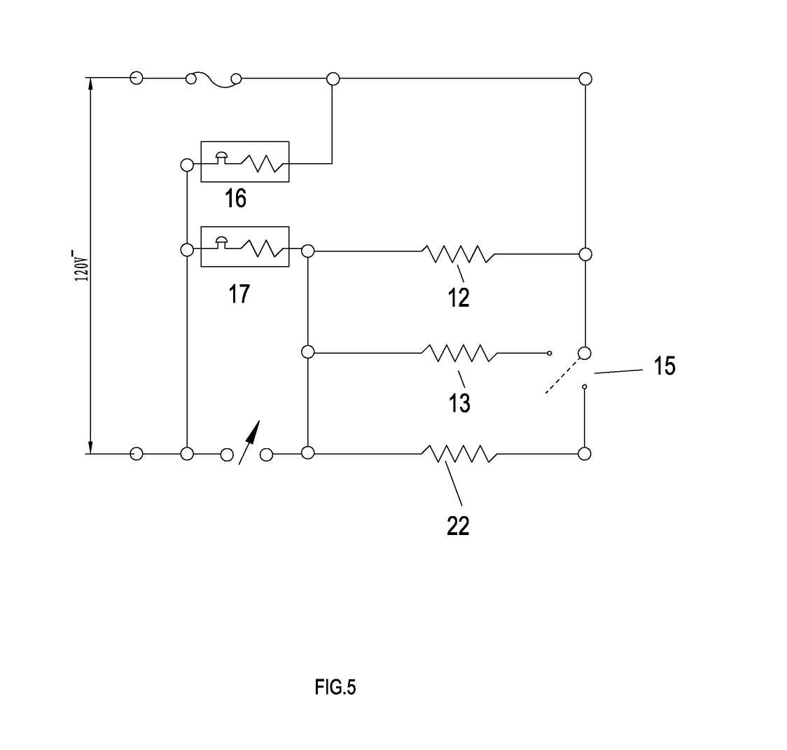

Referring to FIG. 5, it is a circuit diagram of the present invention.

Herein the 16 is power indicator lamp, and 17 is a ready indicator lamp. The second electrical heating tube 13 and the upper electrical heating tube 22 are switched by the switch 15, thus the two electrical heating tubes are electrically connected to the first electrical heating tube 12 alternatively. By the FIG. 5, those skilled in the art can complete the circuit without any creative work.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with detailed description, but rather by the claims appended hereto.

What is claimed is:

1. An alternate grill comprising:
an upper pan and a lower pan, and an upper heating member and a lower heating member for heating the two pans respectively, wherein
said lower heating member comprising at least a first heating unit and a second heating unit, in the position that the two pans are folded as a grill, said upper heating member and said first heating unit are electrified, while said second heating unit is power-off; in the position that the two pans are unfolded as two grilling pans, said second heating unit and said first heating unit are electrified, while said upper heating member is power-off.

2. The alternate grill according to claim 1 further comprising a switch for switching the power-on or power-off status for said upper heating member and said second heating unit alternately.

3. The alternate grill according to claim 1, wherein said upper heating member and lower heating member are electrical heating tubes.

4. The alternate grill according to claim 2, wherein said upper heating member and lower heating member are electrical heating tubes.

5. The alternate grill according to claim 1, wherein said second heating unit is parallel to the first heating unit around the outer side by a certain distance.

6. The alternate grill according to claim 2, wherein said second heating unit is parallel to the first heating unit around the outer side by a certain distance.

7. The alternate grill according to claim 1, wherein said upper pan and said lower pan have a folded position, a 105° position and a 180° position to each other.

8. The alternate grill according to claim 2, wherein said upper pan and said lower pan have a folded position, a 105° position and a 180° position to each other.
